(19) United States
(12) Patent Application Publication
(10) Pub. No.: US 2026/0124564 A1
(43) Pub. Date: May 7, 2026

(54) FILTER ASSEMBLY WITH ENHANCED SEALING MEACHNISM

(71) Applicant: Water Filters Pty Ltd, Osborne Park (AU)

(72) Inventors: Juan David ESCOBAR, Osborne Park (AU); Jagadeesha ANGADI, Osborne Park (AU)

(21) Appl. No.: 19/366,570

(22) Filed: Oct. 23, 2025

(30) Foreign Application Priority Data
Nov. 6, 2024 (AU) 2024259773

(51) Int. Cl. B01D 35/30

(52) U.S. Cl. CPC B01D 35/30; B01D 2201/291; B01D 2201/304; B01D 2201/34

(57) ABSTRACT

The present disclosure relates to a filter assembly comprising a housing, a cap, a cartridge and a sealing member. The housing includes a first portion and a second portion. The cap is attached to the first portion and includes an inlet to receive a fluid. The cartridge is adapted to be positioned within the housing and comprises a first end with an outlet, a filtration chamber, a filter media and contoured surface. The filtration chamber receives the fluid from the inlet for filtration. The filter media is disposed within the filtration chamber and filters unwanted elements from the fluid. The contoured surface is formed around the outlet at the first end and extends along a longitudinal axis of the cartridge. The sealing member engages with the contoured surface to form a fluid-tight seal in a secured arrangement of the cartridge along with the sealing member within the housing.

### TECHNICAL FIELD

The present disclosure generally relates to the field of fluid filtration systems. In particular, the present disclosure relates to an advanced filter assembly designed to enhance fluid filtration performance through an improved sealing configuration.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in prior arts. The subject matter in the background section merely represents different approaches, which in and of themselves may correspond to implementations of the claimed technology.

Water filtration systems play a vital role in delivering clean, safe drinking water by removing impurities, contaminants, and particulate matter. The water filtration systems are widely used in residential, commercial, and industrial applications to enhance water quality, providing users with water that meets health and safety standards. Achieving a reliable seal in the water filtration systems is essential to ensure that all water flows through a filtration media and no contaminants bypasses the filtration media. However, conventional sealing mechanisms in water filtration systems often exhibit several shortcomings that affect their performance, hygiene, and durability over time.

Existing water filtration systems typically includes filter cartridges with two open ends, one at the top and one at the bottom, which deteriorates over time resulting in poor sealing and significantly increasing the risk of water bypass. This design flaw allows unfiltered water to bypass the filtration media, compromising the effectiveness of filtration process. For the water filtration systems designed to remove specific pathogens, even a small percentage of water bypass renders the system ineffective, undermining its purpose.

Another critical issue with the existing water filtration systems is reliance on washers at the top and bottom of filters to create a seal. This washer-based design, however, introduces several challenges. For instance, the washers are formed of rubbers or similar materials and are susceptible to mold growth. The washers are exposed to both filtered water and unfiltered water, and in many cases, the filtered water lacks disinfectants like chlorine, creating an ideal environment for the mold growth. Furthermore, prolonged exposure to non-chlorinated filtered water leads to microbial buildup on washers, which contaminates the filtered water, degrading the quality of the filtered water, leading to potential health risks for consumers.

Additionally, the rubber washers used in the existing water filtration systems tend to deteriorate over time, posing a contamination risk due to microplastic release. On prolonged exposure to moisture and pressure, the washers degrade and shed microplastic particles, which can enter the filtered water. This microplastic contamination poses serious health concerns, since the microplastic particles are not easily removed from the water supply and leads to negative health impacts.

Further, a common sealing technique in the existing water filtration systems is use of knife-edge compression, which involves applying direct force against a washer to create a seal. FIG. 1A illustrates a top view of an underside portion of a housing cap 100 of a filtration system, in accordance with prior arts. The housing cap 100 includes a recess 110 formed within its inner surface. The recess 110 is formed as a cylindrical portion adapted to position a washer 120 engaged with an outlet of a filter cartridge. The recess 110 is pressed directly against the washer 120. FIG. 1B illustrates a two-dimensional view of a top portion 100′ of the filter cartridge, in accordance with the prior arts. FIG. 1C illustrates a top view of the washer 120, in accordance with the prior arts. The filter cartridge has an outlet including a profile for engaging with the washer 120. The arrangement of the outlet, the recess 110 and the washer 120 results in the knife-edge compression on the washer 120. For example, knife edge compression points are shown as dotted lines 121. When the housing cap 100 is tightened, intense pressure is applied on the washer 120. Over time, this pressure leads to cutting into or deforming of the washer material. Once cut, the washer 120 loses its integrity, leading to gaps in the seal. Even a minor compromise in the seal can cause significant degradation in the filter's performance, especially in the water filtration systems designed to meet strict safety and filtration standards. Furthermore, the washer 120 has portion that is in contact with the clean water, internal area of the knife edge compression points which are shown as dotted lines 121, that leads to the washers degradation and shedding of microplastic particles, which can enter the filtered water.

Moreover, chemical degradation further affects the durability of the washers. When exposed to certain water conditions or contaminants, the rubber washers deteriorate, requiring frequent replacements to maintain an effective seal. This degradation increases the operational cost of the existing water filtration systems and disrupts its reliability, which is critical for delivering consistently safe drinking water. Accordingly, the existing water filtration systems suffer from inadequate sealing, leading to compromised filtration efficiency, potential fluid leakage, and difficulty in maintenance due to wear and misalignment of sealing components.

Another limitation of the washers in the existing water filtration systems is their tendency to undergo permanent deformation due to prolonged pressure. As the washers lose their elasticity and fail to rebound to their original shape, the seal weakens, allowing water to bypass the filtration media. This deformation not only reduces the effectiveness of the filtration systems but also demands regular maintenance and inspections to ensure the filtration system operates as intended.

In view of the aforementioned challenges associated with the existing water filtration systems, there is a need for an advanced filter assembly featuring an advanced sealing configuration which not only optimizes filtration performance but also reduces maintenance requirements and extends the operational life of the filter assembly.

### SUMMARY

The summary is provided to introduce aspects related to swimming pool design and a method of construction of the swimming pool, and the aspects are further described below in the detailed description. This summary is not intended to identify essential features of the claimed subject matter nor is it intended for use in determining or limiting the scope of the claimed subject matter.

According to a first aspect of the present disclosure, a filter assembly is disclosed. The filter assembly includes a housing, a cap, and a cartridge. The housing includes a first portion and a second portion. The cap is attached to the first portion of the housing and includes an inlet to receive a fluid. The cartridge is adapted to be positioned within the housing. The cartridge includes a first end with an outlet, a filtration chamber, a filter media, and a contoured surface. The filtration chamber is adapted to receive the fluid from the inlet for filtration. The filter media is disposed within the filtration chamber. The filter media is adapted to filter one or more of unwanted elements from the fluid. The contoured surface is formed around the outlet at the first end and extends along a longitudinal axis of the cartridge. The filter assembly further includes a sealing member adapted to engage with the contoured surface to form a fluid-tight seal in a secured arrangement of the cartridge along with the sealing member within the housing, wherein the contoured surface corresponds to a surface having one or more of a compound slope, a curved slope, a concave slope, a convex slope, a chamfered edge, or a stepped slope, to optimize the engagement with the sealing member.

In one or more implementations, the cartridge includes a second end having a closed surface.

In one or more implementations, the sealing member is adapted to be isolated from filtered fluid and exposed only to unfiltered fluid.

In one or more implementations, the sealing member includes an inner profile adapted to complement a profile of the contoured surface providing an increased contact surface.

In one or more implementations, the inner profile of the sealing member includes rings adapted to receive effective pressure from the contoured surface of the outlet.

In one or more implementations, the sealing member is adapted to be subjected to a lateral compression from the contoured surface of the outlet.

In one or more implementations, an exterior of the outlet includes a conical portion, and the contoured surface is provided on the conical portion.

In one or more implementations, the contoured surface includes a top curved slope portion with a land. The land is adapted for initial engagement with the sealing member and the top curved slope portion is adapted for providing a progressive sealing compression as the sealing member is engaged with the contoured surface.

In one or more implementations, the contoured surface includes a top curved slope portion with a land. The land is adapted for initial engagement with the sealing member and the top curved slope portion is adapted for providing a progressive sealing compression as the sealing member is engaged with the contoured surface.

In one or more implementations, the cap includes a recess formed within an inner surface of the cap. The recess has a shaped profile adapted to conform to an external profile of the sealing member and compress the sealing member engaged with the contoured surface radially to provide the fluid-tight seal.

In one or more implementations, the recess includes a stepped portion adapted for incremental engagement with the sealing member.

According to another aspect of the present disclosure, an assembly is disclosed. The assembly includes a housing, an inner unit, and a sealing member. The inner unit is positioned within the housing. The inner unit includes an outlet and a contoured surface around the outlet. The sealing member is adapted to engage with the contoured surface of the outlet to form a tight seal in a secured arrangement of the inner unit along with the sealing member within the housing.

In one or more implementations, the housing includes a recess formed within an inner surface. The recess includes a shaped profile adapted to conform to an external profile of the sealing member and compress the sealing member engaged with the contoured surface radially to enable the tight seal.

In one or more implementations, the recess includes a stepped portion adapted for incremental engagement with the sealing member.

Other aspects and advantages of the present disclosure will become apparent from the following description, taken in conjunction with the accompanying drawings, illustrating by way of example, the principles of the present disclosure.

### BRIEF DESCRIPTION OF DRAWINGS

Non-limiting and non-exhaustive embodiments of the disclosure are described with reference to the following figures, wherein reference numerals refer to like parts throughout the various views unless otherwise specified. The accompanying drawings constitute a part of the description and are used to provide a further understanding of the present disclosure. Such accompanying drawings illustrate the embodiments of the present disclosure used to describe the principles of the present disclosure. The embodiments are illustrated by way of example and not by way of limitation in the figures of the accompanying drawings in which references indicate similar elements. It should be noted that references to “an” or “one” embodiment in this disclosure are not necessarily to the same embodiment, and they mean at least one. In the drawings:

FIG. 1A illustrates a top view of an underside portion of a housing cap of a filtration system, in accordance with prior arts.

FIG. 1B illustrates a two-dimensional view of a top portion of a filter cartridge, in accordance with the prior arts.

FIG. 1C illustrates a top view of a waster, in accordance with the prior arts.

FIG. 2A illustrates a perspective view of a filter assembly, in accordance with an embodiment of the present disclosure.

FIG. 2B illustrates a perspective view of the filter assembly excluding a housing cap, in accordance with an embodiment of the present disclosure.

FIG. 2C illustrates a perspective view of the filter assembly including the housing cap, in accordance with an embodiment of the present disclosure.

FIG. 3A illustrates a top view of a top surface of the housing cap, in accordance with an embodiment of the present disclosure.

FIG. 3B illustrates a top view of an underside portion of the housing cap, in accordance with an embodiment of the present disclosure.

FIG. 4A and FIG. 4B illustrate perspective views of a cartridge of the filter assembly, in accordance with embodiments of the present disclosure.

FIG. 5A and FIG. 5B illustrate different two-dimensional views of a first portion of the cartridge, in accordance with an embodiment of the present disclosure.

FIG. 5C illustrates a perspective view of the first portion of the cartridge, in accordance with an embodiment of the present disclosure.

FIG. 5D illustrates a perspective view of the first portion of the cartridge including a contoured surface engaged with a sealing member, in accordance with an embodiment of the present disclosure.

FIG. 6A through FIG. 6L illustrate different profiles of the contoured surface, in accordance with different embodiments of the present disclosure.

FIG. 7A and FIG. 7B illustrate top views of the sealing member, in accordance with an embodiment of the present disclosure.

FIG. 7C illustrates a perspective view of the sealing member, in accordance with an embodiment of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” or “lateral” or “adjacent” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that the terms used herein should be interpreted as having a meaning that is consistent with their meaning in the context of this specification and the relevant art and will not be interpreted in an idealized or overly formal sense unless expressly so defined herein.

Unless otherwise expressly stated, comparative, quantitative terms such as “less than” and “greater than”, are intended to encompass the concept of equality. As an example, “less” can mean not only “less” in the strictest mathematical sense, but also, “less than or equal to.” The present disclosure relates to an advanced filter assembly designed to enhance fluid filtration performance through improved sealing configurations. Filter assemblies are commonly used to purify fluids by removing unwanted elements such as particulates, biological impurities, chemicals, and the like through filtration media. A critical aspect of performance of a filter assembly lies in a sealing mechanism between a filter cartridge and a housing, which must effectively prevent fluid bypass and contamination. The present disclosure provides an innovative filter assembly featuring an advanced sealing configuration which not only optimizes filtration performance but also reduces maintenance requirements and extends the operational life of the assembly.

An aspect of the present disclosure is to provide an improved filter assembly that can enhance both sealing performance and operational reliability of the filter assembly. Another aspect of the present disclosure is to provide a filter assembly with a sealing member that can engage a contoured surface around an outlet of the cartridge, ensuring a robust fluid-tight seal and preventing the fluid bypass. Yet another aspect of the present disclosure is to provide a filter assembly that can enable effective separation of filtered fluid and unfiltered fluid within the filter assembly, thereby improving filtration efficiency and preventing cross-contamination between the filtered fluid and the unfiltered fluid. A further aspect of the present disclosure is to provide a filter assembly that can enhance durability of the filter assembly by introducing a sealing member with an inner profile that complements the contoured surface of the outlet of the cartridge, which allows for increased contact area and optimized compression.

Another aspect of the present disclosure is to provide a filter assembly that can reduce wear of the sealing member by isolating the sealing member from the filtered fluid, thereby extending the operational life of the filter assembly and minimizing maintenance frequency. Yet another aspect of the present disclosure is to provide a filter assembly that can facilitate easy installation and replacement of the filter cartridge within the housing, reducing the need for specialized tools and minimizing downtime during maintenance.

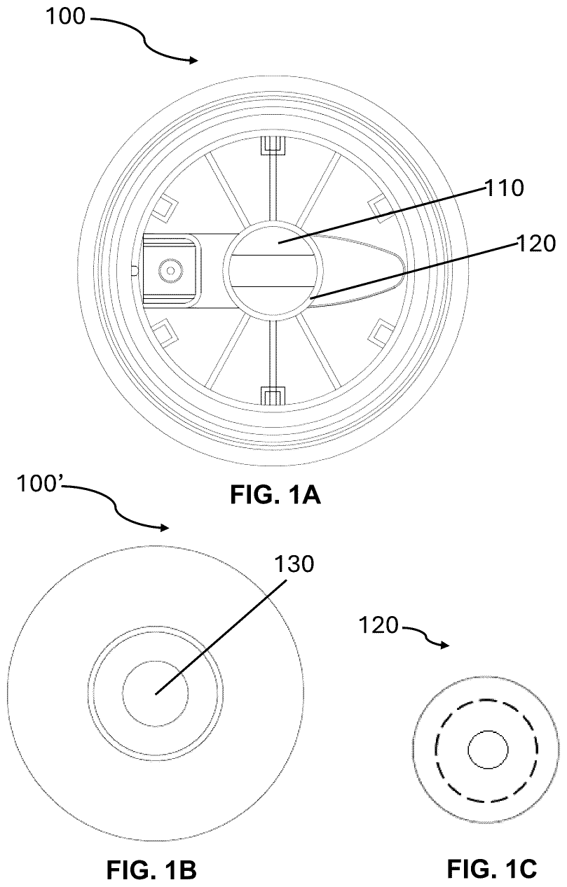

Embodiments of the present disclosure will now be described with reference to FIG. 1 through FIG. 5.

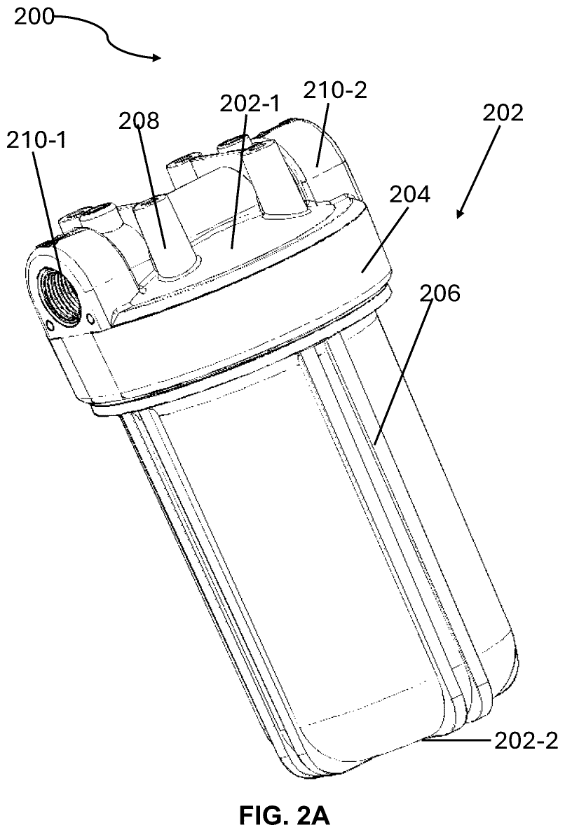

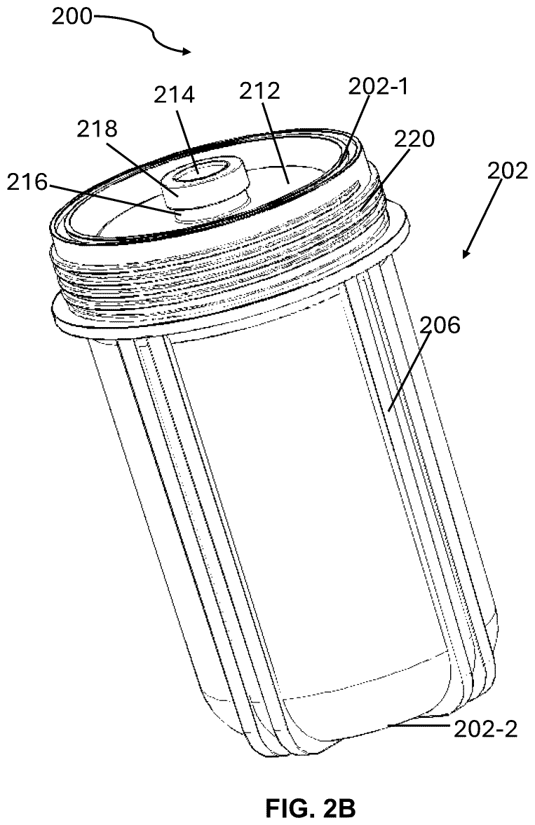

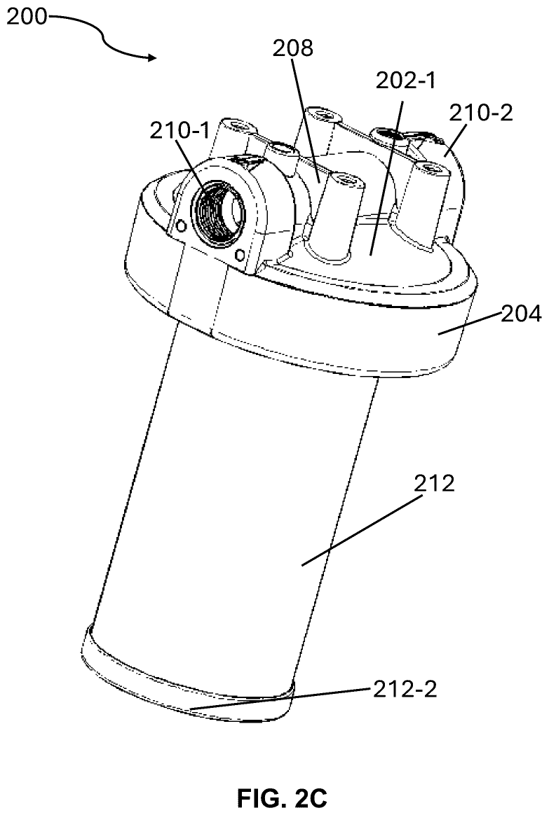

FIG. 2A illustrates a perspective view of a filter assembly 200, in accordance with an embodiment of the present disclosure. The filter assembly 200 (hereinafter may also be referred to as a “filtration assembly 200” or simply an “assembly 200) includes a housing 202, a housing cap 204 (hereinafter may also be referred to as a “cap 204”), and a cartridge (not shown in FIG. 2A).

The housing 202 includes a first portion 202-1 and a second portion 202-2. In an implementation, the first portion 202-1 corresponds to an upper portion of the housing 202 and the second portion 202-2 corresponds to a lower portion of the housing 202. The housing 202 includes first flanges 206 extending radially outward from its outer surface. The first flanges 206 are adapted to provide structural stability and facilitate secure attachment within the filter assembly 200.

The cap 204 is attached to the first portion 202-1 of the housing 202. The cap includes an inlet 210-1 to receive a fluid for filtration and an exit port 210-2 for delivering the filtered fluid for end use. A flow channel (to be explained in detail later with reference to FIG. 2A) extends through the cap 204 and includes the inlet 210-1 and the exit port 210-2. The flow channel has a geometrically optimized profile to regulate fluid flow and reduce flow turbulence. The cap 204 comprises second flanges 208 at its top surface to enable a sealed engagement with a corresponding retaining structure within the filter assembly 200. In an implementation, the housing 202, the cap 204 and the filter assembly 200 are formed of a corrosion-resistant material, such as a high-grade polymer, composite material or stainless steel, to prevent degradation from prolonged exposure to the fluid.

FIG. 2B illustrates a perspective view of the filter assembly 200 excluding the housing cap 204, in accordance with an embodiment of the present disclosure. The filter assembly 200 includes the housing 202 and a cartridge 212.

The cartridge 212 is adapted to be positioned within the housing 202. The cartridge 212 includes an outlet 214 for delivering the filtered fluid. In an implementation, the filter assembly 200 corresponds to an assembly for filtering water and the outlet 214 of the cartridge 212 is adapted to deliver the filtered water.

The cartridge further includes a contoured surface 216 (contour not completely shown in FIG. 2B) formed around the outlet 214. The contoured surface 216 extends along a longitudinal axis of the cartridge 212.

The filter assembly 200 further includes a sealing member 218 adapted to engage with the contoured surface 216 to form a fluid-tight seal in a secured arrangement of the cartridge 212 along with the sealing member 218 within the housing 202. The sealing member 218 is adapted to be potentially isolated from the filtered fluid and exposed only to the unfiltered fluid. The sealing member 218 is further adapted to be subjected to a lateral compression from the contoured surface 216 of the outlet 214.

Referring to FIG. 2B, the filter assembly is in a disassembled condition, i.e., the cap is not attached to the filter assembly 200.

The filter assembly 200 further includes a locking mechanism 220 formed on the housing 202 and corresponding interlocking arrangement provided along inside edges of the cap 204. The locking mechanism 220 is adapted to secure the cap 204 to the housing 202 in a detachable and replaceable manner. A combination of the contoured surface 216, the sealing member 218, and the flow channel geometry is adapted to eliminate the need for additional sealing washers or gaskets, thereby minimizing the risk of contamination and leakage within the filter assembly 200.

FIG. 2C illustrates a perspective view of the filter assembly 200 including the housing cap 204, in accordance with an embodiment of the present disclosure. The filter assembly 200 as shown in FIG. 2C excludes an intermediate portion and the lower potion 202-2 of the housing 202.

The filter assembly 200 includes the cap 204 and the cartridge 212. The cap 204 is attached to the first portion 202-1 of the housing 202. The cap 204 includes the inlet 210-1 for receiving the fluid for a filtration process and the exit port 210-2. The flow channel extending through the cap 204 includes the inlet 210-1 and the exit port 210-2. The cap 204 includes the second flanges 208 at its top surface to enable the sealed engagement with the corresponding retaining structure of the filter assembly 200.

The cartridge 212 includes a first end (not shown in FIG. 2C) having the outlet 214 (shown in FIG. 2B). The cartridge 212 further includes a second end 212-2, which is closed. The cartridge 212 further includes a filtration chamber (not shown in FIG. 2C), a filter media (not shown in FIG. 2C), and the contoured surface 216 (not shown in FIG. 2C). The cartridge 212 is removably mounted within the housing 202, thereby allowing for replacement of the cartridge 202.

The filtration chamber is adapted to receive the fluid from the inlet 210-1 for filtration. The filtration chamber may include a plurality of channels or pathways to direct the flow of input fluid through the filter media, thereby maximizing the contact surface area between the input fluid and the filter media.

The filter media is disposed within the filtration chamber. The filter media is adapted to filter unwanted elements from the fluid. The filter media is selected from one or more of a particulate filter, a chemical adsorption filter, a membrane filter, or a biological filter configured to remove microbial contaminants from the input fluid.

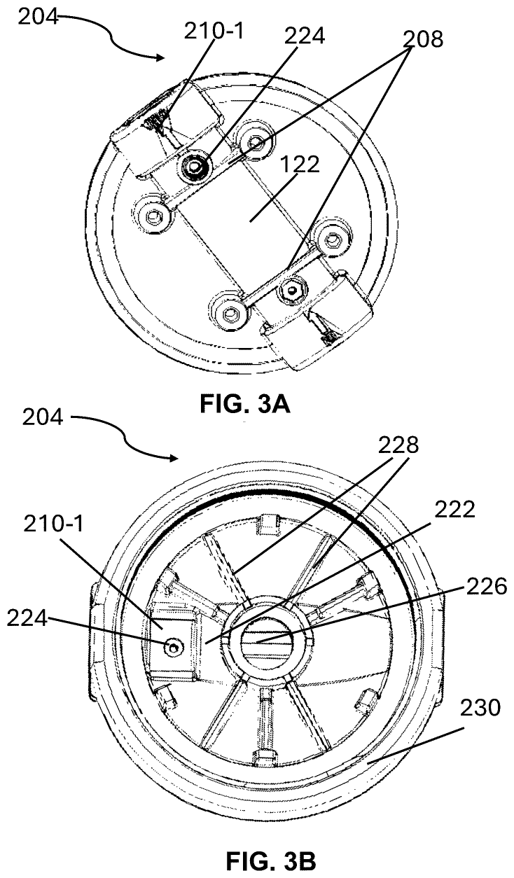

FIG. 3A illustrates a top view of a top surface of the housing cap 204, in accordance with an embodiment of the present disclosure. The cap 204 is attached to the first portion 202-1 (not shown in FIG. 3A) of the housing 202. The cap 204 includes the inlet 210-1, the exit port 210-2 and a flow channel 222.

The inlet 210-1 allows the entry of fluid that needs to be filtered into the filter assembly 200. The flow channel 222 extends radially through a body of the cap 204. The cap 204 includes two second flanges 208, positioned symmetrically on opposite sides. The second flanges 208 play a critical role in enabling a sealed engagement of the housing 202 with a corresponding retaining structure within the filter assembly 200.

The cap 204 further includes a pressure relief valve 224. The pressure relief valve 224 is adapted to be integrated into the cap 204 or the housing 202 to release excess air or pressure that may build up within the filter assembly 200 during its operation. When the fluid enters the filter assembly 200 through the inlet 210-1, air trapped within the housing 202 can create back pressure, affecting the flow and efficiency of filtration. The pressure relief valve 224 helps in venting this air out, allowing for smooth fluid passage and preventing the risk of air locks. The pressure relief valve 224 also prevents excess pressure buildup, which may damage the filter components.

FIG. 3B illustrates a top view of an underside portion of the housing cap 204, in accordance with an embodiment of the present disclosure. The cap 204 includes the flow channel 222, which includes the inlet 210-1 for receiving the unfiltered fluid and the exit port 210-2 for delivering the filtered fluid for end use.

The cap 204 includes a recess 226 formed within its inner surface. The recess 226 is formed as a shaped profile adapted to conform to an external profile of the sealing member 218 and compress the sealing member 218 engaged with the contoured surface 216 radially to provide the fluid-tight seal. In an implementation, the recess 226 comprises a stepped portion adapted for incremental engagement with the sealing member. In an implementation, an external sealing surface of the recess 226 comprises a series of concentric ridges or grooves adapted to enhance the compression and sealing engagement between the recess 226 and the sealing member 218.

The cap 204 further includes reinforcing ribs 228 (hereinafter may also be referred to as ribs 228) extending radially outwards from the recess 226 towards an inner edge of the cap 204. The ribs 228 provide structural support, helping to withstand pressure from the fluid flow and maintaining the integrity of the cap 204 during an operation of the filter assembly 200.

The cap 204 includes the pressure relief valve 224 adapted to release the excess air or pressure build up within the filter assembly 200 during operation. The inner edge of the cap 204 may include an interlocking arrangement 230 that aligns with the locking mechanism 220 on the housing 202. This enables the cap 204 to be securely attached and easily detached from the housing 202, facilitating replacement and maintenance of the cartridge 212.

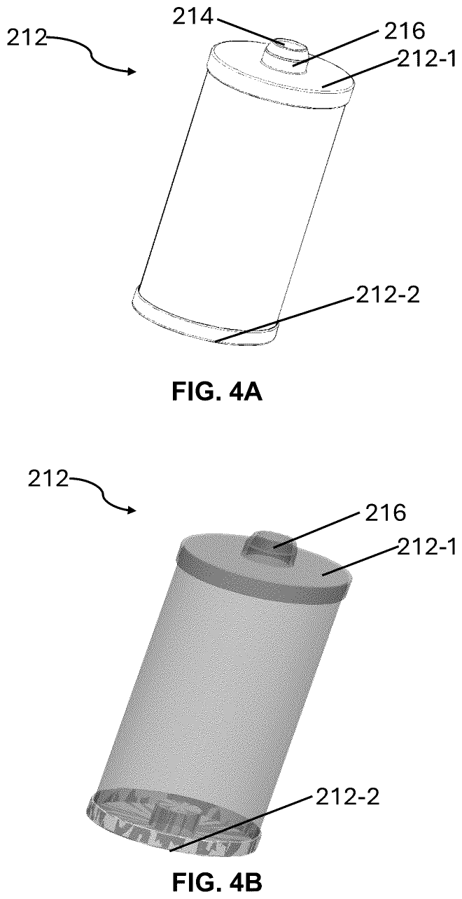

FIG. 4A and FIG. 4B illustrate perspective views of the cartridge 212 of the filter assembly 200, in accordance with embodiments of the present disclosure.

Referring to FIGS. 4A and 4B, the cartridge 212 includes a first end 212-1 (hereinafter may also be referred to as a first portion 212-1) including the outlet 214. The cartridge 212 further includes the second end 212-2 having a closed surface. which is closed. The cartridge further includes the contoured surface 216 formed around the outlet 214. The contoured surface 216 extends along the longitudinal axis of the cartridge 212.

The cartridge 212 includes the sealed second end. This improved design eliminates dual open ends typically seen in conventional filters and reduces the risk of fluid bypass. By sealing off the bottom of the cartridge 212, the design ensures that all fluid flows through the filter media, enhancing overall effectiveness of the filter assembly.

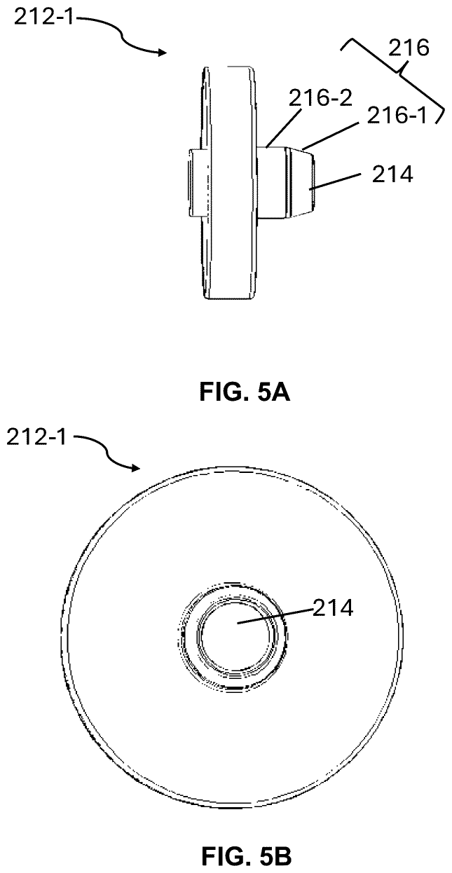

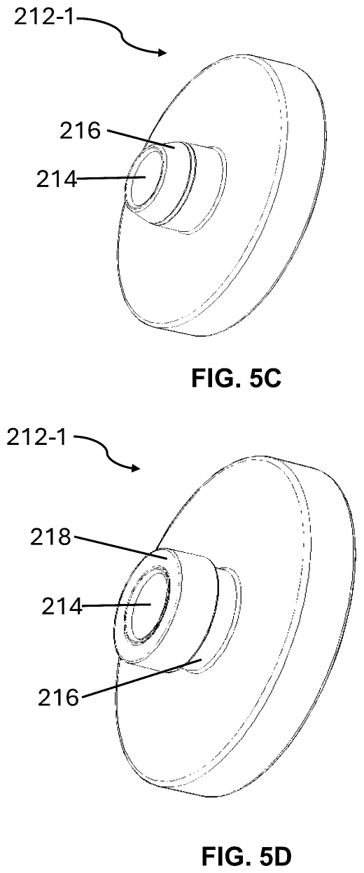

FIG. 5A and FIG. 5B illustrate different two-dimensional views of a first portion of the cartridge 212, in accordance with an embodiment of the present disclosure. FIG. 5C illustrates a perspective view of the first portion of the cartridge 212, in accordance with an embodiment of the present disclosure. FIG. 5D illustrates a perspective view of the first portion of the cartridge 212 including a contoured surface 216 engaged with a sealing member 218, in accordance with an embodiment of the present disclosure.

Referring to FIGS. 5A through 5D, the first portion 212-1 of the cartridge 212 includes the contoured surface 216. The contoured surface 216 is formed around the outlet 214 and is shaped and dimensioned to provide a fluid-tight fit with the sealing member 218. The contoured surface 216 may further include a curved or a tapered profile that reduces turbulence and pressure drop at the outlet 214 to enhance the efficiency of the filtration process. In an implementation, the contoured surface 216 is formed at a taper angle varying from 15 to 60 degrees, optimized to enhance the sealing engagement and facilitate efficient fluid flow through the outlet 214. The contoured surface 216 may include multiple sequential curved profiles, each formed at a different angle to create a multi-stage sealing mechanism that enhances leak resistance under varying fluid pressures. The contoured surface 216 is formed integrally around the outlet 214 and may further have a surface finish with a low roughness value to promote smooth contact with the sealing member 218, thereby enhancing sealing efficiency and reducing potential fluid bypass. The contoured surface 216 is adapted to distribute the pressure evenly across the sealing member 218, thereby preventing localized stress points and reducing the risk of cracking, brittleness, or breakdown of the sealing member 218 over extended periods of use.

In an implementation, the contoured surface 216 includes a surface having one or more of a compound slope, a curved slope, a concave slope, a convex slope, a chamfered edge, or a stepped slope, to optimize the engagement with the sealing member 218. In an implementation, an exterior of the outlet 214 comprises a conical portion, and the contoured surface 216 is provided on the conical portion. In another implementation, the contoured surface 216 comprises a top curved slope portion 216-1 with a land 216-2. The land 216-2 is adapted for initial engagement with the sealing member 218 and the top curved slope portion 216-1 is adapted for providing a progressive sealing compression as the sealing member 218 is engaged with the contoured surface 216.

In an implementation, the contoured surface 216 includes a convex profile designed to direct the fluid flow away from the sealing interface, thereby minimizing turbulence and reducing wear on the sealing member 218 over prolonged use. The contoured surface 216 may be manufactured using precision machining techniques, resulting in a uniform surface finish that minimizes imperfections and maximizes the contact area with the sealing member 218, enhancing the effectiveness of the fluid-tight seal.

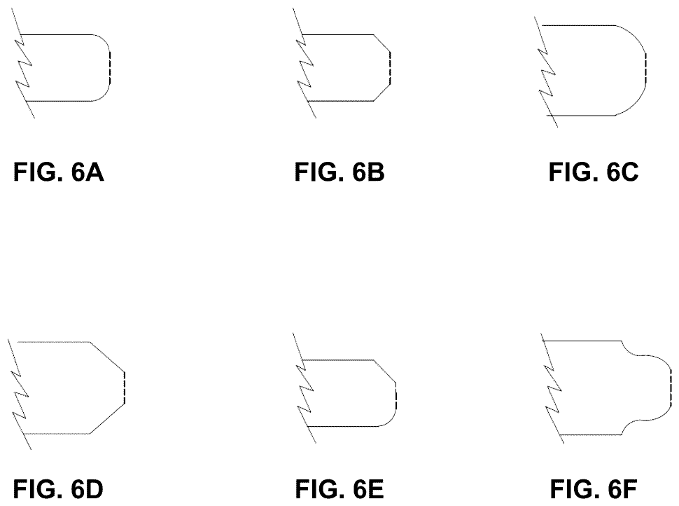

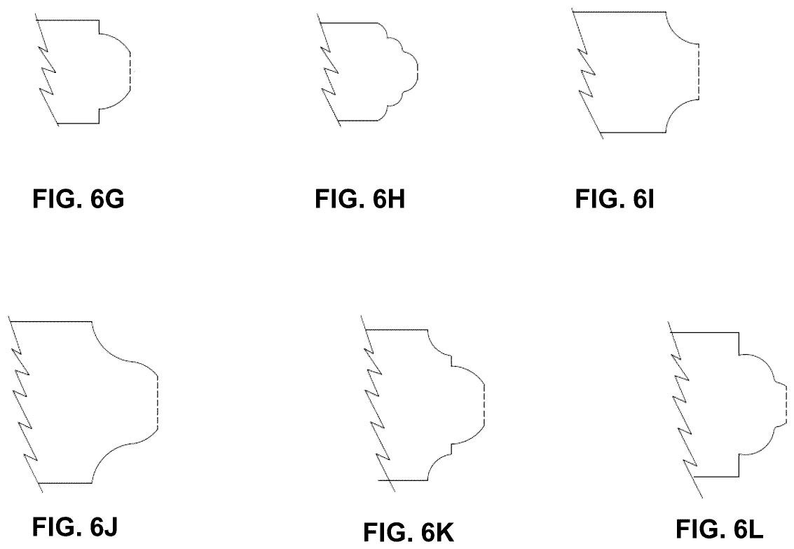

FIG. 6A through FIG. 6L illustrate different profiles of the contoured surface 116, in accordance with different embodiments of the present disclosure. These profiles represent different curved or contoured profiles around the outlet 114 of the outlet, which engages with the sealing member 118. In an implementation, the profiles may include one or more of a rounded or a curved profile, bevel or angled profile, stepped profile, and the like. In another implementation, the contoured surface 216 includes a surface having one or more of a compound slope, a curved slope, a concave slope, a convex slope, a chamfered edge, or a stepped slope, to optimize the engagement with the sealing member 218. The introduction of any of these profiles enhances the seal quality in water filtration systems by preventing knife-edge compression observed in prior arts. By distributing the compression force more evenly, these profiles mitigate the risks associated with degradation of the sealing member and reduce the possibility of water bypass.

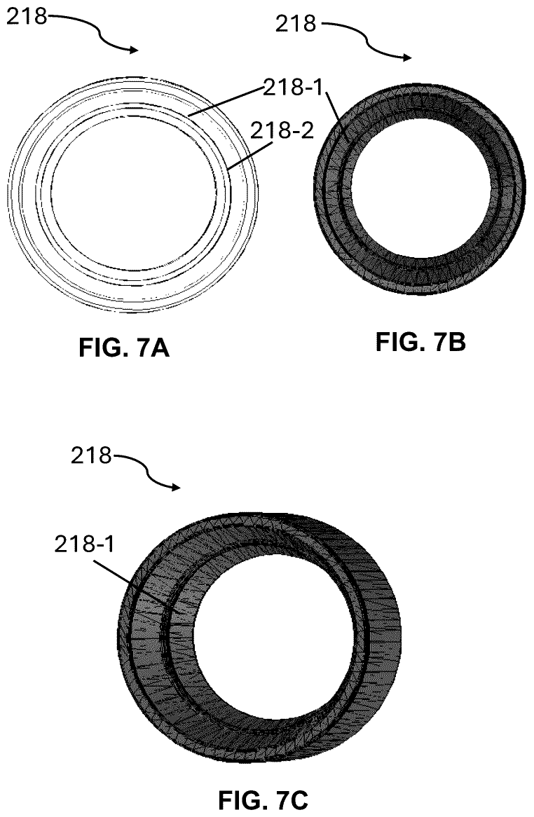

FIG. 7A and FIG. 7B illustrate top views of the sealing member 218, in accordance with an embodiment of the present disclosure. FIG. 7C illustrates a perspective view of the sealing member 218, in accordance with an embodiment of the present disclosure.

Referring to FIGS. 7A through 7C, the sealing member 218 is adapted to engage with the contoured surface 216 to form the fluid-tight seal in a secured arrangement of the cartridge 212 along with the sealing member 218 within the housing 202. The sealing member is adapted to be isolated from the filtered fluid and exposed only to the unfiltered fluid to prevent contamination from mold or chemical degradation. The sealing member 218 comprises an inner profile 218-1 adapted to complement a profile of the contoured surface 216 providing an increased contact surface. In an implementation, the inner profile 218-1 of the sealing member 218 may include rings 218-2 adapted to receive an effective pressure from the contoured surface 216 of exterior of the outlet 214. In another implementation, the sealing member 218 is adapted to be subjected to a lateral compression from the contoured surface 216 of the outlet 214.

The sealing member 218 may be formed of a compressible, elastomeric material that deforms to establish the fluid-tight seal when the cartridge 212 is securely attached fixed with the cap 204 of the housing 202.

The sealing member 218 is adapted to deform upon engagement with the contoured surface 216 to create a watertight seal without requiring additional sealing elements, such as gaskets or washers. The sealing member 218 is integrated with a retention mechanism of the recess 226 within the cap 204 that prevents it from dislodging from its position during operation, ensuring consistent engagement with the contoured surface 216 throughout the filter's lifecycle. The sealing member 218 is adapted to be in alignment with the contoured surface 216 under varying pressure conditions.

Now referring to various advantageous effects of the present disclosure, the present disclosure relates to an improved filter assembly designed for the efficient removal of particulates, chemicals, and biological impurities from liquids. The present disclosure encompasses advancements in filter cartridge design, focusing on structural configurations that improve sealing performance, mitigate contamination risks, and enhance the durability of the filtration process. The filter assembly as disclosed herein the present disclosure is particularly applicable to residential, commercial, and industrial water purification systems, where effective filtration is critical for maintaining water quality and safety. The unique incorporation of the contoured surface, the sealing member, and the recess, each having profiles complementing the mating profiles, in the filter assembly represents a significant improvement over conventional designs, addressing common challenges such as bypass, contamination, and structural failure.

Through features like the sealed bottom end, isolated sealing member, and contoured surface compression, the filter assembly of the present disclosure offers a superior solution that enhances filtration efficiency, minimizes maintenance, and ensures the delivery of consistently safe, high-quality water for consumers.

A person skilled in the art will appreciate that alternative components can be utilized in the described embodiments. However, other embodiments could be implemented without utilizing one or more of these mechanisms.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A filter assembly comprising:
a housing having a first portion and a second portion;
a cap attached to the first portion of the housing, the cap having an inlet to receive a fluid;
a cartridge adapted to be positioned within the housing, wherein the cartridge comprises:
a first end with an outlet;
a filtration chamber adapted to receive the fluid from the inlet for filtration;
a filter media disposed within the filtration chamber, the filter media adapted to filter one or more of unwanted elements from the fluid; and
a contoured surface formed around the outlet at the first end, the contoured surface extending along a longitudinal axis of the cartridge; and
a sealing member adapted to engage with the contoured surface to form a fluid-tight seal in a secured arrangement of the cartridge along with the sealing member within the housing. wherein the contoured surface corresponds to a surface having one or more of a compound slope, a curved slope, a concave slope, a convex slope, a chamfered edge, or a stepped slope, to optimize the engagement with the sealing member.

2. The filter assembly of claim 1, wherein the cartridge comprises a second end having a closed surface.

3. The filter assembly of claim 1, wherein the sealing member is adapted to be isolated from filtered fluid and exposed only to unfiltered fluid.

4. The filter assembly of claim 1, wherein the sealing member comprises an inner profile adapted to complement a profile of the contoured surface providing an increased contact surface.

5. The filter assembly of claim 4, wherein the inner profile of the sealing member comprises rings adapted to receive an effective pressure from the contoured surface of the outlet.

6. The filter assembly of claim 5, wherein the sealing member is adapted to be subjected to a lateral compression from the contoured surface of the outlet.

7. The filter assembly of claim 1, wherein an exterior of the outlet comprises a conical portion, and the contoured surface is provided on the conical portion.

8. The filter assembly of claim 1, wherein the contoured surface comprises a top curved slope portion with a land, the land adapted for initial engagement with the sealing member and the top curved slope portion adapted for providing a progressive sealing compression as the sealing member is engaged with the contoured surface.

9. The filter assembly of claim 1, wherein the cap comprises a recess formed within an inner surface of the cap, the recess having a shaped profile adapted to:
conform to an external profile of the sealing member; and
compress the sealing member engaged with the contoured surface radially to provide the fluid-tight seal.

10. The filter assembly of claim 9, wherein the recess comprises a stepped portion adapted for incremental engagement with the sealing member.
